(19) United States
(12) Patent Application Publication
(10) Pub. No.: US 2008/0181399 A1
(43) Pub. Date: Jul. 31, 2008

(54) COMPOSITE CRYPTOGRAPHIC ACCELERATOR AND HARDWARE SECURITY MODULE

(75) Inventors: Joel M. Weise, Burlingame, CA (US); Gary D. Morton, Erie, CO (US)

Correspondence Address: HOGAN & HARTSON LLP, ONE TABOR CENTER, SUITE 1500, 1200 SEVENTEEN ST., DENVER, CO, 80202, US

(73) Assignee: SUN MICROSYSTEMS, INC., Santa Clara, CA (US)

(21) Appl. No.: 11/668,358

(22) Filed: Jan. 29, 2007

(51) Int. Cl. H04L 9/28

(52) U.S. Cl. 380/44; 380/28

(57) ABSTRACT

The functionality of a hardware security module is combined with that of a cryptographic accelerator in a single device. A single device comprising a hardware security module configured to generate and securely store at least one cryptographic key is combined with hardware configured to accelerate cryptographic computations associated with a plurality of encryption algorithms. The cryptographic keys generated are managed entirely within the composite HSM cryptographic accelerator. Once generated, cryptographic keys may be stored either within the device or outside the device in an encrypted form. The master key used to encrypt the cryptographic keys remains within the device at all times and is isolated on a separate bus. Clear text versions of the cryptographic keys are not accessible outside of the composite HSM cryptographic accelerator.

### BACKGROUND OF THE INVENTION

1. Field of the Invention.

Embodiments of the present invention relate, in general, to cryptography and particularly to the secure management of cryptographic keys in conjunction with financially related transactions.

2. Relevant Background.

In any electronic exchange of information between two or more participants, cryptography is intended to provide assurances such as confidentiality (no one except the intended participant(s) will have access to the information exchanged), authentication (each participant is confident of the identities of the other participant), integrity (the information exchanged between the participants will have nothing added or removed without the participants being aware of the alteration), and non-repudiation (a sender of information cannot deny having sent the information, and a recipient of the information cannot deny its reception).

These assurances are essential to the growth of secure electronic communications and have gained significant importance in the area of electronic communications dealing with financial transactions. One of the biggest problems associated with conventional (symmetric/single key) cryptography relates to the distribution and control of the secret keys used to encrypt and decrypt data in secure communication sessions. Modem public key cryptography, which uses public/private key pairs, attempts to overcome this problem, but public key encryption carries a very large computational overhead in comparison to that associated with conventional encryption. As a way of limiting this overhead, many cryptographic protocols only use public key encryption as a mechanism to allow participants setting up a secure communication session to exchange secret/private keys. The exchanged keys are then used in, for example, conventional encryption to encrypt the bulk of data to be transmitted in the session and other cryptography based functions such as data validation.

The terms “key” and “cryptographic key”, as referred to herein, are in the context of symmetrical keys as used in accordance with the Data Encryption Standard (DES) as well as other cryptography standard known to those skilled in the art, and/or public/private key pairs used in accordance with a Public Key Infrastructure (PKI). It is understood that these terms are not limited solely to use in this field. The terms “key” and “cryptographic key”, in addition to their conventional meaning, may be used herein to refer to any information which it is necessary to be in possession of or use in order that a secure operation can be performed in conjunction with corresponding complementary data providing a useful result.

Modem personal computing systems, with suitable software, are capable of implementing both conventional and public key encryption mechanisms in order to complete secure electronic transactions (for example Web shopping or Internet banking). The computing overheads and physical security required are not beyond the resources of a typical end-user PC provided that it does not need to carry out a large number of such transactions within a short period of time. However, this is not the case for the commercial server systems with which these transactions are conducted. These e-commerce and financial server systems are naturally expected to be able to conduct large numbers of transactions within short periods of time and must be able to guarantee for each transaction a high degree of physical and logical security.

Since the computational requirements of public key cryptography during a typical financial transaction are high, this activity becomes a bottleneck as compared to the normal overheads of the administration and logistics of computer based commercial order-processing systems. One attempt to alleviate this bottleneck is the implementation of devices known in the art as cryptographic accelerators. A cryptographic accelerator uses dedicated cryptographic hardware to perform the same cryptographic functions that a central processing unit would otherwise perform with software. Not only can encryption and decryption be performed faster in hardware than in software, but the computational burden of the central processing unit can also be dramatically reduced, allowing it to perform other important tasks. A cryptographic accelerator may therefore be thought of as a cryptographic co-central processing unit.

Another approach to relieving some of the burden placed on computer systems designed or designated to handle cryptographically intensive service provisions has been to use dedicated cryptographic modules such as commercially available Hardware Security Modules (HSMs). A HSM is a hardware-based security device that can generate, store and protect cryptographic keys. Typically the job of a HSM is to securely generate long term secrets for use in a cryptographic function and physically protect the access to, and use of, these secrets. Typically these secrets are private keys used in private/public key cryptography. Similarly, symmetrical keys used in secret key cryptography can also be protected by some HSMs. It is important to note that the keys protected by a typical HSM are only truly protected if generated and maintained inside the hardware. Importing a software protected key into an HSM means that a non-hardware protected copy of the key may exist. Furthermore, exporting keys outside the HSM may also compromise the key's security and while HSMs of the prior art can perform cryptographic algorithms performance is severely constrained. HSM available from various vendors can be connected to computer systems individually or in a cluster to provide cryptographic processing used by the computer systems. The cluster can form a scalable distributed server in which cryptographic operations are distributed for processing among the computer systems in the cluster according to load balancing criteria. HSMs are extremely valuable to services necessitating secure operations such as financial institutions.

Financial service based cryptographic functions such as processing credit card transactions, debit card transactions, home banking, Personal Identification Number (PIN) management, key management, etc, and cryptographic acceleration functions such as establishing a Secure Socket Layer (SSL) connection and Internet Protocol security (“IPsec”) for web based transactions are generally preformed by distinct and separate components. Each device adds complexity and operational management to an enterprise's information technology environment. Furthermore and as suggested previously, transferring intermediate cryptographic results between these components using the host system hardware or software can expose confidential information. Keys that are not generated and stored within an HSM are not secure. This complexity impedes overall security, efficiency and throughput.

### SUMMARY OF THE INVENTION

Briefly stated, embodiments of the present invention involve a single device combining the functionality of a hardware security module directed toward financial transactions with that of a cryptographic accelerator. According to one embodiment of the present invention, a device comprising a hardware security module configured to generate and store at least one cryptographic key is combined with hardware configured to accelerate cryptographic computations associated with a plurality of encryption algorithms.

According to another aspect of the present invention, cryptographic keys are generated and managed entirely within the composite HSM cryptographic accelerator. Once generated, cryptographic keys may be stored either within the device or outside the device in an encrypted form. The master key used to encrypt the cryptographic keys remains isolated within the device at all times and is isolated in secure memory. Clear text version of the cryptographic keys are not accessible outside of the composite HSM cryptographic accelerator.

Another aspect of the present invention includes a composite HSM cryptographic accelerator configured for use with respect to financial transactions. The HSM portion of the device is, in one embodiment of the present invention, configured to validate personal identification numbers and authenticate credit and debit card transactions using accelerated cryptographic hardware. Various cryptography techniques using hardware to increase the efficiencies of the transactions are utilized within the device to increase the efficiency of the transaction without risking the security of the data due to transmission of unsecured intermediate results. In another aspect of the present invention, both symmetric and asymmetric cryptography is used in the performance of requested secure transactions.

The features and advantages described in this disclosure and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 shows a high level block diagram of a composite hardware security module and cryptographic accelerator device according to one embodiment of the present invention;

FIG. 2 shows a high level block diagram of the functional components of a composite hardware security module and cryptographic accelerator device according to one embodiment of the present invention;

FIG. 3 shows a high level block diagram of the cryptographic accelerator structure of a composite hardware security module and cryptographic accelerator device according to one embodiment of the present invention;

FIG. 4 shows a high level block diagram of key management components of a composite hardware security module and cryptographic accelerator device according to one embodiment of the present invention; and

FIG. 5 shows a high level block diagram of the hardware security module structure of a composite hardware security module and cryptographic accelerator according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

Specific embodiments of the present invention are hereafter described in detail with reference to the accompanying figures. Like elements in the various figures are identified by like reference numerals for consistency. Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention.

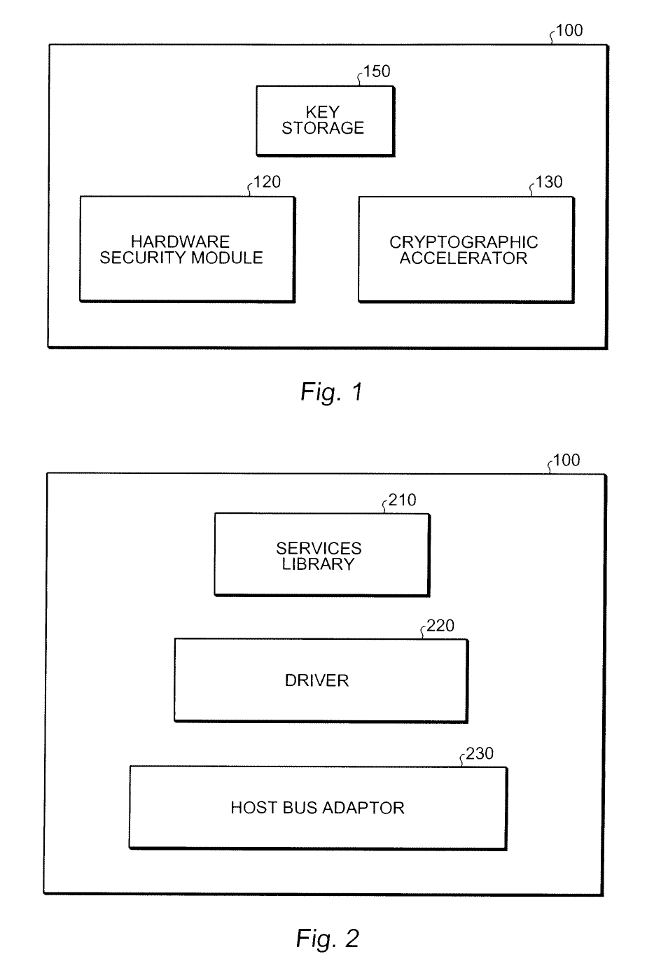

FIG. 1 shows a high level block diagram of a composite hardware security module and cryptographic accelerator according to one embodiment of the present invention. A single composite HSM cryptographic accelerator 100 housing both HSM 120 functionality and cryptographic acceleration 130 as well as the means to store/manage 150 cryptographic keys is herein described. The composite HSM cryptographic accelerator 100 combines high speed and accelerated network/data encryption such as SSL and IPsec with independent cryptographic applications such as validation protocols used for debit and credit card transactions. Embodiments of the present invention combine financial and other related services related to cryptographic transactions with high performance hardware supported cryptographic functionality.

One significant aspect of the present invention includes secure key management. The secure management of cryptographic keys within a single device greatly facilitates secure financial transactions. While once data is encrypted the transference of that data remains secure, the management of the private and public keys that create such a secure environment can be compromised when such keys are managed in an unsecured manner. This unsecure key management jeopardizes the data itself. For example, storage of keys in one device and utilization of those keys in another forces the cryptographic keys to be transported by the host operating system. While both the processing of the keys and their storage may be secure, the host operating system has access to unsecured or clear text copies of the keys. Individuals with knowledge of and access to the host operating system possess the opportunity to compromise the security of the keys and thus the encrypted data. In addition the employment of cryptographic accelerator technology to facilitate the processing of a large volume of cryptographic transactions traditionally involves the conveyance of the cryptographic keys to the dedicated cryptographic hardware or accelerators. Again, the security of the cryptographic keys may be compromised. Embodiments of the present invention eliminate this concern by conducting validation, acceleration, and key management within a single device thus limiting access to the cryptographic keys by the host operating system.

Similarly, embodiments of the present invention enable commands to be chained together such that intermediate results, including intermediate cryptographic results are not disclosed. Specific functional environments, such as those dealing with financial transactions, conduct a series of commands in sequence to optimize the cryptographic functionality. Traditionally commands and command sequences are hard coded into firmware. By chaining these commands within a single device as directed by an application using the device, multiple cryptographic based validation protocols or similar applications can be run concurrently creating improved system efficiencies. For example, traditional HSMs possess separate commands for PIN decryption, PIN verification, and card verification. Embodiments of the present invention using command chaining allow these three similar functions to be combined into a single request comprising three commands.

While exemplary embodiments of the present invention are described with respect to financially related transactions such as PIN verification and validation of bank card transactions, one skilled in the art will recognize that the concepts disclosed herein are equally applicable to other applications involving cryptographic resources. Indeed the descriptions of the embodiments presented herein are by way of example and are not intended to be exclusive in any manner with respect to the breadth of the present invention's application to other market sectors.

Electronic financial services such as on-line or home banking, credit card transactions and debit card transactions, require a high degree of security. Likewise, brokerages, insurance companies, and health-care services and functions require a high degree of security with respect to identification, authentication, and validation of users, customers, patients, etc. These services require cryptographic keys to be managed, imported and exported. In addition, PINs, passwords, tokens, challenges and other authentication means related to financial transactions such as those conducted during on-line banking or using a bank card must be created and verified with respect to each individual using a card or PIN. Embodiments of the present invention load cryptographic keys into specific hardware supporting these types of applications without the intervention of the host operating system, hardware, or software. According to another embodiment of the present invention commands are formatted using contiguous blocks of data preventing disclosure of intermediate cryptographic results.

FIG. 2 depicts a high level block diagram of key components of a composite HSM cryptographic accelerator according to one embodiment of the present invention. In one exemplary embodiment of the present invention a composite HSM cryptographic accelerator comprises a services library 210, drivers 220 for managing application firmware, and a host bus adapter 230. The services library 210 possesses data necessary for the implementation of various cryptographic functionality and provides the interface needed to transport user requests between the user applications and the host bus adapter 230. With respect to financially related services this may include associations of various cryptographic keys with PINs, accounts, credit cards, etc. Certainly the present invention is equally applicable to any market sector that requires secure identification, validation and/or authentication of users.

The driver 220 acts as an interface between the application seeking the cryptographic functionality offered by the composite HSM cryptographic accelerator 100 and the particular hardware components contained within. The driver 220 enables interaction with cryptographic hardware by interfacing with firmware resident on the crypto accelerator/HSM 100. This firmware can be securely downloaded using the administrative client 440. The host bus adapter 230 enables the composite HSM cryptographic accelerator to securely communicate with other portions of the host or network as appropriate. In one embodiment of the present invention the composite HSM cryptographic accelerator 100 supports Peripheral Component Interface express (“PCIe”) connections using multiple lanes.

One aspect of the composite HSM cryptographic accelerator 100 is cryptographic key support. To ensure cryptographic keys never appear to the host in clear text, the composite HSM cryptographic accelerator, in one embodiment of the present invention, enables users of the device to generate, distribute, use, store, and manage keys and keying material using the composite HSM cryptographic accelerator. The device of the present invention is capable of extracting or importing keys and other cryptographic material from other sources as well as securely creating keys from multiple clear text components. The composite HSM cryptographic accelerator 100 can also export these components without divulging the key itself.

The versatility and usefulness of the present invention can be realized by following a typical financially related service. A credit card transaction is a secure transaction between a retailer and a financial institution. Typically the retailer receives a card from the customer as a form of payment. The retailer then electronically contacts the financial institution to verify the validity of the card and to ensure the authorized bearer of the card possesses enough credit to conduct the desired transaction. During this process the card itself is verified as being a valid card. Once validated, the card is associated with a specific account and that account's credit history. When the card is a debit card, personal identification via a PIN also takes place. Each of these processes requires specific cryptographic techniques. For example one technique of credit card validation is a simple check sum calculation conducted at the point of sale combined with validation techniques such as associating the card with a proper billing zip code.

Once an application (user) seeks to employ various cryptographic services such as validation of a credit card or authentication of a personal identification, the application conveys the components of the information in clear text to the composite HSM cryptographic accelerator which then generates or retrieves a stored key so as to secure the transaction. In the credit card example, once the retailer has communicated to the financial institution that it wishes to undergo a credit card transaction, the composite HSM cryptographic accelerator is accessed to secure the credit card number and associated verification numbers, dollar amount, credit history, etc. with a secure key. Validation techniques are accomplished using dedicated accelerator hardware within the device such that intermediate results with respect to the validation of the card remains within the device.

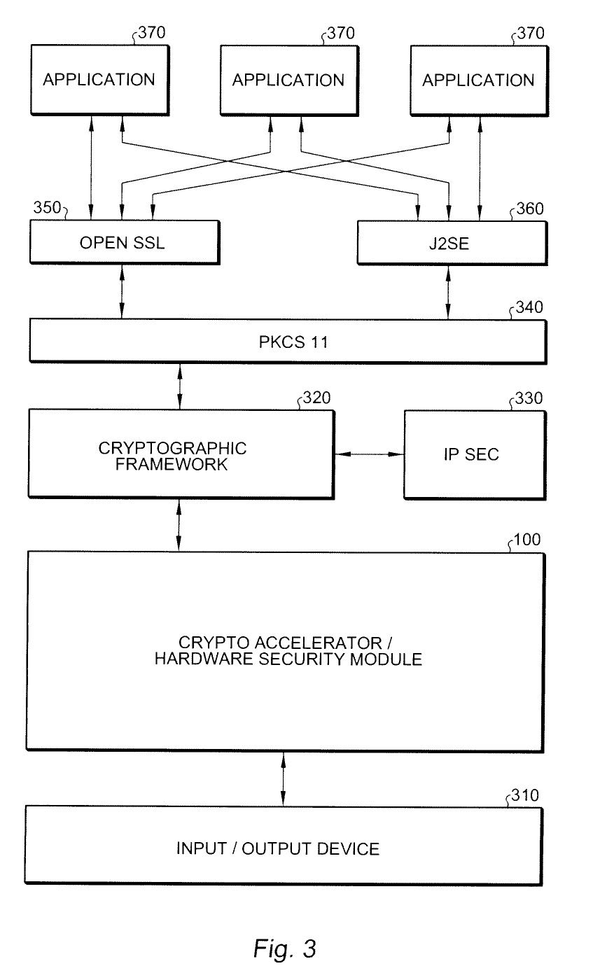

FIG. 3 shows a high level block diagram of the cryptographic accelerator functionality of the composite HSM cryptographic accelerator according to one embodiment of the present invention. The composite HSM cryptographic accelerator 100 is functionally interposed between an input/output device 310 and a cryptographic framework 320. In one embodiment of the present invention, the cryptographic framework 320 interacts with users and/or applications 370 via a SSL 350 connection or a Java Platform such as J2SE 360. Between the SSL or J2SE portal is a module 340 implementing Public-Key Cryptography Standards #11 (“PKCS #11”). Public Key Cryptography Standard number 11 (“PKCS #11”) specifies a platform generic Application Program Interface (“API”), often called Cryptoki, that is a cryptographic token interface that presents to applications a common, logical view of a device. PKCS #11 is a generic interface to HSMs. PKCS #11 defines a technology-independent programming interface, for interfacing with cryptographic devices such as smart cards and, in this case, the composite HSM cryptographic accelerator.

Applications 370 generally do not provide generalized cryptographic services. For example a send-mail mail server application role is to route e-mail to its intended recipient, not encrypt the message. In doing so it may need to employ other services to encrypt the message and thus access a cryptographic framework 320. The framework 320 provides an abstracted and consistent interface to cryptographic services offered by the composite HSM cryptographic accelerator 100. In one embodiment of the present invention the cryptographic framework 320 does not include any cryptography. Rather the cryptography is found within the composite HSM cryptographic accelerator 100. Cryptographic components of the composite HSM cryptographic accelerator include software and hardware implementations of cryptographic techniques such as exponential key exchange, advanced encryption standard, data encryption standard, triple data encryption standard, Rivest Shamir Adleman, digital signal algorithm, message-digest algorithm 5, secure hash algorithm, random number generation, elliptical curve cryptography and the like.

The cryptographic framework 320, according to one embodiment of the present invention, uses IPsec protocols or SSL to secure the communications between the applications 370 and the composite HSM cryptographic accelerator 100. IPsec operates on the network layer while other Internet security protocols such as SSL operate on the transport layer. In this regard IPsec is more flexible. Typically, requests from the applications 370 are tunneled to the composite HSM cryptographic accelerator 100 via the PKCS #11 340 and cryptographic framework 320.

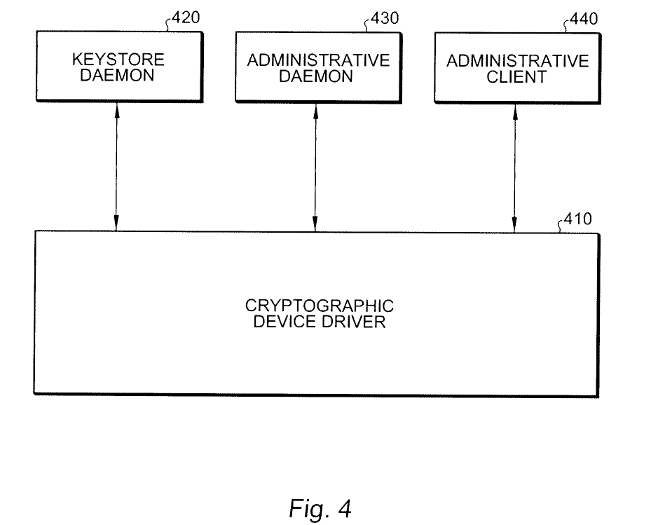

Referring additionally to FIG. 4, a high level block diagram of key management components of composite hardware security module and cryptographic accelerator according to one embodiment of the present invention are shown. As previously described, management of cryptographic keys are of vital concern in secure transactions. This concern is accentuated with respect to transactions involving financial, health-care and other similar data. To ensure the security of keys is maintained, the present invention provides for a secure storage of long-term private keys.

Cryptographic keys, according to one embodiment of the present invention, are stored, as shown in FIG. 1, in an encrypted format. The master key to encrypt or decrypt these cryptographic keys is maintained within the composite HSM cryptographic accelerator 100 in on-board memory 150 in an isolated bus. This storage mechanism ensures that there can be no host access to clear text copies of sensitive cryptographic keys. From the component perspective, key management functionality comprises firmware, a key-store input/output daemon 420 and a driver 410. Firmware is responsible for handling the keys in clear text and handling key-store management requests from the administrative client 440, which provides a host based interface, and is routed through the administrative daemon 430, which provides a secure interface bypassing the host. The key-store daemon 420 is responsible for backing up and retrieving the key-store material from the host system. This material is maintained in an encrypted format using the master key. Finally the driver 410 is responsible for providing connectively between firmware and the administrative client 440 as well as the key-store daemon 420.

Key management is a central aspect of the present invention. Accordingly, embodiments of the present invention employ cryptographic key management principles including key access control, random key generation, limitations to allowable key forms, dual key control, split knowledge, audit trails, recognized intended key usage, key compromise techniques, risk compartmentalization, cryptographic strength procedures, and key management documentation.

As cryptographic keys are the foundation of any secure communication; when a key is compromised all higher level security and integrity controls upon which the key is based are also compromised. Thus key management and security are of vital interest. The cryptographic keys of the present invention are never accessible outside the composite HSM cryptographic accelerator 100 in a clear text form. Furthermore, the keys generated by composite HSM cryptographic accelerator 100 are done so in a random manner so that is it not possible to predict any key or determine that certain values are more probable than others. The number of states that keys may exist in is also limited. This reduces the opportunity for the keys to be compromised. According to embodiments of the present invention, clear text version of the keys only occur within the confines of the composite HSM cryptographic accelerator 100. Furthermore, clear text version of the keys within the device comprise at least two separate components each controlled by separate key custodians using techniques of dual controls and split knowledge. Dual control means that no one person shall have the capability to obtain, determine, use, alter or ascertain a clear text key or more than one clear text component of a key. Split knowledge ensures that the two key custodians do not have knowledge or awareness of another's keys, key components, or keying material.

Embodiments of the present invention also employ limiting the use of the keys for specific defined functions. This helps isolate any corruption that may occur from the compromise of a key. Finally the present invention employs techniques to identify and manage compromised keys. These and other key management functionalities are all maintained within the composite HSM cryptographic accelerator 100.

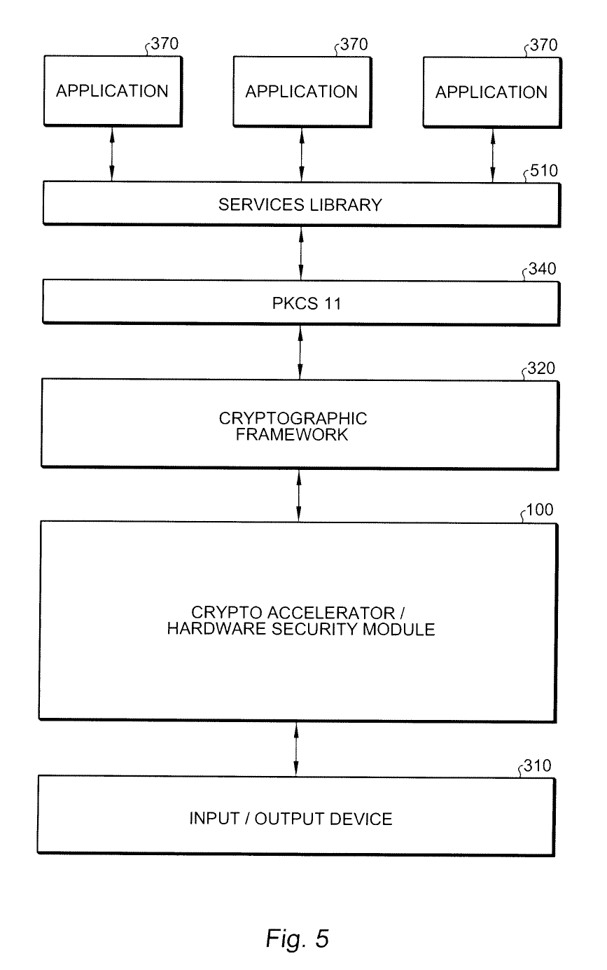

FIG. 5 shows in addition to the previous figures a high level block diagram of the functional components of the hardware security module structure of a HSM cryptographic accelerator according to one embodiment of the present invention. Financial service applications 370 are connectively coupled to the composite HSM cryptographic accelerator 100 via a services library 510, a PKCS #11 interface 340, and the cryptographic framework 320. In this exemplary embodiment of the present invention, the PKCS #11 interface is used to tunnel commands between the financial applications 370 and the composite HSM cryptographic accelerator's 100 firmware. In most cases the commands are proprietary with respect to each application and thus not recognizable by the PKCS #11 protocols. The financial services library (or in general a services library) 510 provides to the composite HSM cryptographic accelerator 100 application program interfaces (“APIs”) for each financial application 370. Drivers within the composite HSM cryptographic accelerator 100 deliver the requests from the applications 370 to the devices 100 firmware and ultimate cryptographic hardware. The firmware is responsible for implementing the requested processing functions within the composite HSM cryptographic accelerator 100.

Although the invention has been described and illustrated with a certain degree of particularity, especially with respect to financial transactions, it is understood that the present disclosure has been made only by way of example, and that numerous changes in the combination and arrangement of parts can be resorted to by those skilled in the art without departing from the spirit and scope of the invention, as hereinafter claimed.

It will also be understood by those familiar with the art, the invention may be embodied in other specific forms without departing from the spirit or essential characteristics thereof. Likewise, the particular naming and division of the modules, managers, functions, systems, engines, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, functions, systems, engines, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

We claim:

1. A cryptographic device combining cryptographic functionality for generating and protecting secrets with dedicated cryptographic hardware, the cryptographic device comprising:
memory;
a security module including a software portion configured to generate at least one cryptographic key and encrypt the at least one cryptographic key using a master key, wherein the master key is stored within the memory, and a software portion configured to manage the use of the at least one cryptographic key in performance of at least one service related application; and
cryptographic hardware configured to accelerate computation of cryptographic functionalities using the at least one cryptographic key in performance of the at least one service related application.

2. The cryptographic device of claim 1 wherein the security module is configured to perform symmetric and asymmetric cryptography.

3. The cryptographic device of claim 1 wherein cryptographic commands are chained together such that intermediate cryptographic results remain secure.

4. The cryptographic device of claim 3 wherein the security module within the cryptographic device is configured to generate, translate, and validate personal identification numbers to provide consumer authentication.

5. The cryptographic device of claim 1 wherein commands directed by an application using the cryptographic device can be run concurrently within the device.

6. The cryptographic device of claim 5 wherein the security module within the cryptographic device is configured to generate card verification values and to associate those values with valid consumer cards.

7. The cryptographic device of claim 1 wherein the cryptographic device concurrently and securely stores in the memory the at least one cryptographic key while the at least one cryptographic key is used in conjunction with the at least on service application.

8. The cryptographic device of claim 1 wherein the cryptographic hardware is configured to support at least one cryptographic algorithm.

9. The cryptographic device of claim 8 wherein the at least one cryptographic algorithm is selected from a group consisting of exponential key exchange, advanced encryption standard, data encryption standard, triple data encryption standard, Rivest Shamir Adleman, digital signal algorithm, message-digest algorithm 5, secure hash algorithm and random number generation.

10. The cryptographic device of claim 1 further comprising an input/output interface configured to support peripheral component interface express protocols.

11. The cryptographic device of claim 1 wherein the security module includes a services library that includes a plurality of application program interfaces and a software driver to interact with the cryptographic hardware, and where commands directed by an application using the cryptographic device are formed using contiguous blocks of data such that intermediate cryptographic results are not disclosed.

12. A system for secure cryptographic key management in financially related services, the system comprising:
a software portion configured to generate at least one cryptographic key and encrypt the at least one cryptographic key using a master key, the master key remaining within the cryptographic device;
a software portion configured to manage the use of the at least one cryptographic key in performance of at least one financially related service application;
a software portion configured to transport requests generated by the at least one financially related service application to cryptographic hardware constructed to accelerate computation of cryptographic functionalities identified by the at least one financially related service application using the at least one cryptographic key wherein transport of the at least one cryptographic key is conducted entirely within the system.

13. The system of claim 12 further comprising a memory configured to securely store the master key.

14. The system of claim 12 wherein the software portion configured to manage the use of the at least one cryptographic key is configured to perform symmetric and asymmetric cryptography.

15. The system of claim 12 wherein cryptographic hardware is configured to generate, translate, and validate personal identification numbers to provide consumer authentication.

16. The system of claim 12 wherein cryptographic hardware is configured to support at least one cryptographic algorithm.

17. The system of claim 16 wherein the at least one cryptographic algorithm is selected from a group consisting of exponential key exchange, advanced encryption standard, data encryption standard, triple data encryption standard, Rivest Shamir Adleman, digital signal algorithm, message-digest algorithm 5, secure hash algorithm and random number generation.

18. The system of claim 12 further comprising a services library that includes an application program interface to interact with each at least one financially related service application.

19. A cryptographic device, comprising:
a security module including a software portion configured to generate at least one cryptographic key and encrypt the at least one cryptographic key using a master key, wherein the master key is stored within the cryptographic device, and a software portion configured to manage the use of the at least one cryptographic key in performance of chaining together commands directed by at least one service related application such that intermediate cryptographic results are unavailable outside of the cryptographic device; and
cryptographic hardware configured to accelerate computation of cryptographic functionalities as directed by the at least on service related application using the at least one cryptographic key.

20. The device of claim 19 wherein the commands directed by the at least one service related application are formed using contiguous blocks of data.
